(19) United States
(12) Patent Application Publication
(10) Pub. No.: US 2005/0191520 A1
(43) Pub. Date: Sep. 1, 2005

(54) Shapable electroluminescent arrangement

(75) Inventors: Udo Guntermann, Krefeld (DE); Friedrich Jonas, Aachen (DE)

Correspondence Address: BAYER MATERIAL SCIENCE LLC, 100 BAYER ROAD, PITTSBURGH, PA, 15205, US

(73) Assignee: H.C. Starck GmbH

(21) Appl. No.: 11/064,914

(22) Filed: Feb. 24, 2005

(30) Foreign Application Priority Data
Feb. 27, 2004 (DE) 102004010145.0

(51) Int. Cl. H05B 33/12

(52) U.S. Cl. 428/690; 428/917; 313/506; 313/509; 427/66

(57) ABSTRACT

Electroluminescent arrangements that are shapeable are described. The electroluminescent arrangement includes, in superposed sequence: (a) at least one transparent carrier film; (b) at least one transparent electrode; (c) at least one electroluminescent layer; (d) at least one dielectric layer; and (e) at least one counter-electrode. In addition, the electroluminescent arrangement: (I) further includes a conductive electrode layer containing at least one conductive polymer that is (i) superposed over the exterior surface of the counter-electrode, or (ii) interposed between the dielectric layer and the counter-electrode; or (II) the counter-electrode thereof is a conductive electrode layer containing at least one conductive polymer. Also described are shaped articles comprising the electroluminescent arrangement, and methods of preparing such shaped articles.

### CROSS REFERENCE TO RELATED PATENT APPLICATION

The present patent application claims the right of priority under 35 U.S.C. §119 (a)-(d) of German Patent Application No. 102004010145, filed Feb. 27, 2004.

### FIELD OF THE INVENTION

The present invention relates to shapable electroluminescent arrangements, to their production and use.

### BACKGROUND OF THE INVENTION

Electroluminescent arrangements, also referred to as EL arrangements hereinbelow, based on inorganic luminescent pigments are known. Such arrangements typically have the following representative physical structure:
(1) Transparent carrier film
(2) Transparent electrode
(3) Electroluminescent layer
(4) Dielectric

When an alternating voltage of from 30 to 500 V and from 10 to 5000 Hz is applied, the electroluminescent layer emits lights. The light that is generated is radiated from the arrangement through the transparent electrode.

The individual layers of the EL arrangement are generally applied by screen printing, each individual layer being dried after printing, before the next layer is applied thereto.

In WO-A 03/37039 it is described that EL arrangements can be shaped by means of heat, for example by deep-drawing, if shapable polymers are used as the carrier film.

However, it has been found in practice that, in the case of pronounced shaping, the counter-electrode exhibits cracks after shaping which do not light when the EL arrangement is operated.

### SUMMARY OF THE INVENTION

Accordingly, the object was to find EL arrangements which light over their entire surface even after shaping. A further object was, therefore, to provide EL arrangements in which the formation of cracks in the counter-electrode during shaping or the formation of faults by other measures can be prevented or compensated for.

Surprisingly, it has been found that the occurrence of non-lighting areas in EL arrangements, that is to say of faults, can be prevented if a further shapable electrode layer based on organic conductive polymers is provided either beneath or on top of the counter-electrode, or a shapable electrode layer based on organic conductive polymers is used as the counter-electrode.

The present invention accordingly provides an electroluminescent arrangement comprising at least one transparent carrier film, at least one transparent electrode, at least one electroluminescent layer, at least one dielectric layer and at least one counter-electrode, characterised in that a conductive electrode layer comprising at least one conductive polymer is located on the counter-electrode or between the dielectric layer and the counter-electrode, or the counter-electrode is a conductive electrode layer comprising at least one conductive polymer.

More particularly, in accordance with the present invention, there is provided an electroluminescent arrangement comprising:
(a) at least one transparent carrier film;
(b) at least one transparent electrode;
(c) at least one electroluminescent layer;
(d) at least one dielectric layer; and
(e) at least one counter-electrode,
   wherein said transparent electrode is interposed between said transparent carrier film and said electroluminescent layer, said dielectric layer is interposed between said electroluminescent layer and said counter-electrode, said transparent carrier film has an exterior surface, and said counter-electrode has an exterior surface,
   further wherein one of,
(I) said electroluminescent arrangement further comprises a conductive electrode layer comprising at least one conductive polymer, said conductive electrode layer being one of,
   (i) superposed over the exterior surface of said counter-electrode, or
   (ii) interposed between said dielectric layer and said counter-electrode,
or
(II) the counter-electrode is a conductive electrode layer comprising at least one conductive polymer.

The features that characterize the present invention are pointed out with particularity in the claims, which are annexed to and form a part of this disclosure. These and other features of the invention, its operating advantages and the specific objects obtained by its use will be more fully understood from the following detailed description and accompanying drawings in which preferred embodiments of the invention are illustrated and described.

Unless otherwise indicated, all numbers or expressions used in the specification and claims are understood as modified in all instances by the term “about.”

### BRIEF DESCRIPTION OF THE DRAWINGS

FIG. 1 is a representative diagram, in exploded view, of a comparative electroluminescent arrangement, as described further in the Comparison Example herein;

FIG. 2 is a representative sectional view of the electroluminescent arrangement of FIG. 1 prior to deep-drawing;

FIG. 3 is a representative sectional view of the electroluminescent arrangement of FIG. 1 after deep-drawing at a temperature of 250° C.;

FIG. 4 is a representative diagram, in exploded view, of a electroluminescent arrangement according to the present invention, as further described in Example 1 herein;

FIG. 5 is a representative diagram, in exploded view, of a electroluminescent arrangement according to the present invention, as further described in Example 2 herein; and

FIG. 6 is a representative diagram, in exploded view, of a electroluminescent arrangement according to the present invention, as further described in Example 3 herein.

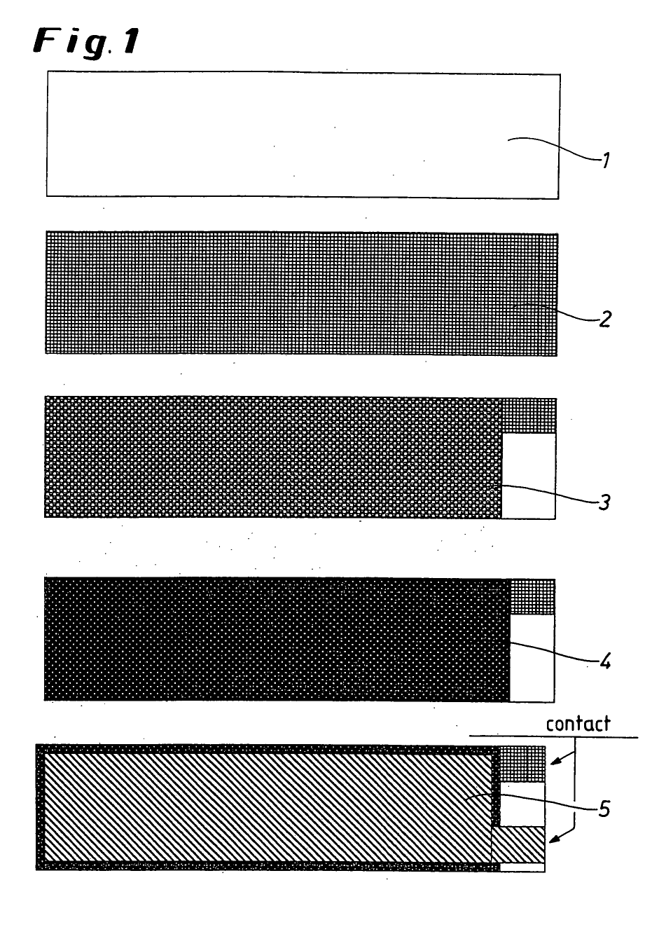

In FIGS. 1 through 6, like reference numerals designate the same components and structural features, unless otherwise indicated.

### DETAILED DESCRIPTION OF THE INVENTION

Within the scope of the invention, conductive polymers may preferably be optionally substituted polythiophenes, polyanilines, polyphenylenes, poly(p-phenylenevinylenes) or polypyrroles. The conductive electrode layer may-also comprise mixtures of two or more such conductive polymers.

Particularly preferred conductive polymers are optionally substituted polythiophenes containing repeating units of the general formula (I) 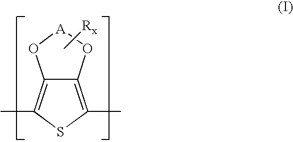
wherein
A represents an optionally substituted C₁-C₅-alkylene radical, preferably an optionally substituted ethylene or propylene radical,
R represents a linear or branched, optionally substituted C₁-C₁₈-alkyl radical, preferably a linear or branched, optionally substituted C₁-C₁₄-alkyl radical, an optionally substituted C₅-C₁₂-cycloalkyl radical, an optionally substituted C₆-C₁₄-aryl radical, an optionally substituted C₇-C₁₈-aralkyl radical, an optionally substituted C₁-C₄-hydroxyalkyl radical or a hydroxyl radical,
x represents an integer from 0 to 8, preferably 0, 1 or 2, particularly preferably 0 or 1, and
where a plurality of radicals R are bonded to A, those radicals may be identical or different.

The general formula (I) is to be understood as meaning that the substituent R may be bonded x times to the alkylene radical A.

In preferred embodiments, polythiophenes containing repeating units of the general formula (I) are those that contain repeating units of the general formula (Ia) 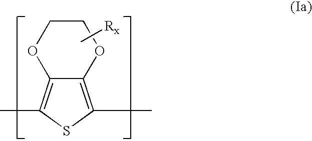
wherein
R and x are as defined above.

In further preferred embodiments, polythiophenes containing repeating units of the general formula (I) are those that contain repeating units of the general formula (Iaa)

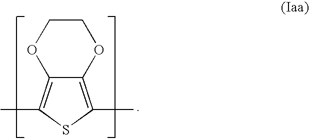

The prefix “poly-” within the scope of the invention is to be understood as meaning that more than one identical or different repeating unit is present in the polymer or thiophene. The polythiophenes contain a total of n repeating units of the general formula (I), where n may be an integer from 2 to 2000, preferably from 2 to 100. The repeating units of the general formula (I) within a polythiophene may be identical or different. Preference is given to polythiophenes containing identical repeating units of the general formula (I).

At the terminal groups, the polythiophenes preferably carry H in each case.

In a particularly preferred embodiment, the polythiophene containing repeating units of the general formula (I) is poly(3,4-ethylenedioxythiophene), that is to say a homopolythiophene comprising repeating units of formula (Iaa).

Within the scope of the invention, C₁-C₅-alkylene radicals A are methylene, ethylene, n-propylene, n-butylene or n-pentylene. Within the scope of the invention, C₁-C₁₈-alkyl represents linear or branched C₁-C₁₈-alkyl radicals, such as, for example, methyl, ethyl, n- or iso-propyl, n-, iso-, sec.- or tert.-butyl, n-pentyl, 1-methylbutyl, 2-methylbutyl, 3-methylbutyl, 1-ethylpropyl, 1,1-dimethylpropyl, 1,2-dimethylpropyl, 2,2-dimethylpropyl, n-hexyl, n-heptyl, n-octyl, 2-ethylhexyl, n-nonyl, n-decyl, n-undecyl, n-dodecyl, n-tridecyl, n-tetradecyl, n-hexadecyl or n-octadecyl; C₅-C₁₂-cycloalkyl represents C₅-C₁₂-cycloalkyl radicals such as, for example, cyclopentyl, cyclohexyl, cycloheptyl, cyclooctyl, cyclononyl or cyclodecyl; C₅-C₁₄-aryl represents C₅-C₁₄-aryl radicals such as, for example, phenyl or naphthyl; and C₇-C₁₈-aralkyl represents C₇-C₁₈-aralkyl radicals such as, for example, benzyl, o-, m-, p-tolyl, 2,3-, 2,4-, 2,5-, 2,6-, 3,4-, 3,5-xylyl or mesityl. The above list serves to illustrate the invention by way of example and is not to be regarded as conclusive.

Suitable optional further substituents of the C₁-C₅-alkylene radicals A are numerous organic groups, for example alkyl, cycloalkyl, aryl, halogen, ether, thioether, disulfide, sulfoxide, sulfone, sulfonate, amino, aldehyde, keto, carboxylic acid ester, carboxylic acid, carbonate, carboxylate, cyano, alkylsilane and alkoxysilane group's, and also carboxylamide groups.

The conductive polymers or polythiophenes may be neutral or cationic. In preferred embodiments they are cationic, “cationic” relating only to the charges on the polymer or polythiophene main chain. Depending on the substituent on the radicals R, the polymers or polythiophenes may carry positive and negative charges in the structural unit, the positive charges being located on the polymer or polythiophene main chain and the negative charges optionally being located on the radicals R substituted by sulfonate or carboxylate groups. Some or all of the positive charges of the polymer or polythiophene main chain may be saturated by the anionic groups optionally present on the radicals R. Considered overall, the polymers or polythiophenes in such cases may be cationic; neutral or even anionic. Nevertheless, they are all regarded as cationic polymers or polythiophenes within the scope of the invention, because the positive charges on the polymer or polythiophene main chain are decisive. The positive charges are not shown in the formulae because their precise number and position cannot be determined definitely. However, the number of positive charges is at least 1 and not more than n, n being the total number of all repeating units (identical or different) within the polymer or polythiophene. Cationic polymers and polythiophenes are also referred to as polycations hereinbelow.

In order to compensate for the positive charge, in so far as this has not already been effected by the optionally sulfonate- or carboxylate-substituted and accordingly negatively charged radicals R, the cationic polymers or polythiophenes require anions as counter-ions.

Suitable counter-ions are preferably polymeric anions, also referred to as polyanions hereinbelow.

The present invention accordingly preferably provides electroluminescent arrangements in which the conductive electrode layer comprises at least one conductive polymer as polycation and at least one polyanion.

Examples of suitable polyanions are anions of polymeric carboxylic acids, such as polyacrylic acids, polymethacrylic acid or polymaleic acids, or anions of polymeric sulfonic acids, such as polystyrenesulfonic acids and polyvinylsulfonic acids. These polycarboxylic and polysulfonic acids may also be copolymers of vinylcarboxylic and vinylsulfonic acids with other polymerisable monomers, such as acrylic acid esters and styrene.

The anion of polystyrenesulfonic acid (PSS) is particularly preferred as the polymeric anion.

The molecular weight of the polyacids supplying the polyanions is preferably from 1000 to 2,000,000, particularly preferably from 2000 to 500,000. The polyacids or their alkali salts are commercially available, for example polystyrenesulfonic acids and polyacrylic acids, or can be prepared by known 1,5 processes (see e.g. Houben Weyl, Methoden der organischen Chemie, Vol. E 20 Makromolekulare Stoffe, Part 2, (1987), p. 1141 et seq.).

Cationic polythiophenes which contain anions as counter-ions for charge compensation are often also referred to among experts as polythiophene/(poly)anion complexes.

In the layer comprising at least one polyanion and at least one polycation, the polyanion may act as the counter-ion. It is, however, also possible for additional counter-ions to be present in the layer. It is, however, preferable for the polyanion to serve as the counter-ion in this layer.

Polyanion(s) and polycation(s) may be present in the layer in a weight ratio of from 0.5:1 to 50:1, preferably from 1:1 to 30:1, particularly preferably from 2:1 to 20:1: The weight of the polycations corresponds to the original weight of the monomers used, assuming that complete conversion takes place in the polymerisation.

In preferred embodiments of the present invention, the conductive electrode layer comprises 3,4-poly(ethylenedioxythiophene) and polystyrene sulfonate.

The conductive electrode layer has a thickness of, for example, from 0.1 to 20 μm, preferably from 0.1 to 5 μm. Data regarding layer thicknesses in this application relate to the thickness of the layer after drying, unless mentioned otherwise.

Because the electroluminescent arrangements according to the invention are preferably those that are shapable, the use of transparent carrier films of shapable materials is also preferred. Suitable transparent carrier films are films of plastics, for example. Particularly suitable plastics are: polycarbonates, polyesters such as, for example, PET and PEN (polyethylene terephthalate and polyethylene-naphthalene dicarboxylate), copolycarbonates, polysulfone, polyethersulfone (PES), polyimide, polyethylene, polypropylene or cyclic polyolefins or cyclic olefin copolymers (COC), polyvinyl chloride, polystyrene, hydrogenated styrene polymers or hydrogenated styrene copolymers. Transparent carrier films may be, for example, films such as polyester films, PES films from Sumitomo or polycarbonate films from Bayer AG (Makrofol®).

The transparent carrier film has a thickness of, for example, from 10 to 10,000 μm, preferably from 20 to 500 μm.

Examples of suitable materials for transparent electrodes are:
a) metal oxides, e.g. indium-tin oxide (ITO), tin oxide (NESA), doped tin oxide, doped zinc oxide, etc.,
b) semi-transparent metal films, e.g. Au, Pt, Ag, Cu, etc.,
c) semi-transparent conductive polymers, e.g. polythiophenes, polyanilines, polypyrroles, etc..

Preferred materials for the transparent electrode 1 are semi-transparent conductive polymers, with particular preference being given to poly(3,4-ethylenedioxy-thiophene)/polystyrene sulfonate (PEDT/PSS).

The transparent electrode has a thickness of, for example, from 0.1 to 20 μm, preferably from 0.2 to 5 μm.

As luminescent pigments for the electroluminescent layer there are used, for example, encapsulated zinc sulfide pigments.

The electroluminescent layer has a thickness of, for example, from 30 to 100 μm, preferably from 40 to 80 μm.

Barium titanate, for example, is used as the dielectric.

The dielectric layer has a thickness of, for example, from 50 to 150 μm, preferably from 60 to 100 μm.

Unless the counter-electrode is the conductive electrode layer already described above, there are suitable as the counter-electrode, for example, conductive silver electrodes or electrodes based on conductive carbon.

Such a counter-electrode has a thickness of, for example, from 10 to 50 μm, preferably from 15 to 30 μm.

In preferred embodiments, the electroluminescent arrangements according to the invention are those that have been shaped.

Shaping of the electroluminescent arrangements according to the invention can be carried out, for example, by deep-drawing, hot pressing or cold pressing. Shaping is preferably carried out by means of heat, particularly preferably by deep-drawing.

Depending on the plastics used as the carrier film and on the thickness of the carrier film, deep-drawing can be carried out at temperatures of from 50 to 350° C.

After shaping, the electroluminescent arrangements according to the invention can be sprayed on the back with polymers—as described in WO-A 03/37039—in order to increase their mechanical stability. Suitable polymers for spraying on the back are, for example, polycarbonates, polycarbonate/polybutylene terephthalate blends.

In preferred embodiments of the present invention, the arrangements according to the invention are those comprising, in superposed sequence:
1. a transparent carrier film 1
2. a transparent electrode 2
3. an electroluminescent layer 3
4. a dielectric layer 4
5. a counter-electrode 5
6. a conductive electrode layer 6,
   the conductive electrode layer being located on the exterior surface of the counter-electrode.

In further preferred embodiments of the present invention, the arrangements according to the invention are those comprising, in superposed sequence:
1. a transparent carrier film 1
2. a transparent electrode 2
3. an electroluminescent layer 3
4. a dielectric layer 4
5. a conductive electrode layer 6
6. a counter-electrode 5,
   the conductive electrode layer being interposed between the dielectric layer and the counter-electrode.

In further preferred embodiments of the present invention, the arrangements according to the invention are those comprising, in superposed sequence:
1. a transparent carrier film 1
2. a transparent electrode 2
3. an electroluminescent layer 3
4. a dielectric layer 4
5. a conductive electrode layer as the counter-electrode 6.

Surprisingly, the electroluminescent arrangements according to the invention can be subjected to shaping without the occurrence of non-lighting areas in subsequent operation. The electroluminescent arrangements according to the invention light over their entire surface, even after shaping.

The electroluminescent arrangements according to the invention can be produced in a simple manner by application of the individual layers in succession from the gas phase or from solution or dispersion, but preferably by application of as many layers as possible from solution or dispersion. Suitable coating processes therefor are, for example, screen printing, intaglio printing, curtain coating and blade-coating processes, the implementation of which is known to the person skilled in the art. As many of the layers of the electroluminescent arrangements according to the invention as possible are applied by means of screen printing.

For the application of most of the layers, commercially available screen-printing pastes are available. For the application of the electroluminescent layer and of the dielectric layer, appropriate screen-printing pastes from Durel or DuPont, for example, can be used. If the counter-electrode is not the conductive electrode layer, commercially available conductive silver or graphite printing pastes are available for its application (e.g. from Durel, DuPont and Acheson). Examples of suitable screen-printing pastes are mentioned in the examples. For the application of a transparent electrode based on a conductive polymer there is suitable, for example, a screen-printing paste comprising poly(3,4-ethylenedioxythiophene) and polystyrene sulfonate, which is commercially available under the name Baytrone® S V2 (H.C. Starck GmbH). When applying coatings over a large area of about 25 cm² and above, it may be advantageous additionally to apply so-called bus-bars of conductive silver between the transparent electrode and the electroluminescent layer. The commercially available conductive silver pastes are again available therefor.

The conductive electrode layer is likewise preferably applied from solution or dispersion, preferably by the screen-printing process. Advantageously, application by means of screen printing offers the possibility of textured application. Screen-printing pastes suitable therefor are described in WO-A 99/34371, for example.

These are, for example, screen-printing pastes having a viscosity of from 1 to 200 dPas, preferably from 10 to 100 dPas, containing a solution or dispersion containing at least one conductive polymer and also, optionally, at least one polyanion, binders, thickeners, crosslinkers, fillers and/or additives.

Suitable conductive polymers are those already listed above for the electroluminescent arrangement according to the invention, especially poly(3,4-ethylenedioxythiophene).

The screen-printing pastes preferably comprise poly(3,4-ethylenedioxythiophene) cations and polystyrene sulfonate anions, the content thereof in the screen-printing pastes according to the invention being particularly preferably greater than or equal to 2 wt. %. Their preparation is known to the person skilled in the art and is described in WO-A 99/34371.

Solvents suitable for the preparation of the screen-printing pastes are water; alcohols that are at least partly miscible with water, such as methanol, ethanol, isopropanol (2-propanol), n-propanol, n-butanol, glycols such as ethylene glycol, diethylene glycol, propylene glycol, glycol acetate, glycol butyrate, methoxypropyl acetate; ketones such as acetone, methyl ethyl ketone, methyl isobutyl ketone, diacetone alcohol; amides such as N,N-dimethylacetamide, N,N-dimethylformamide, N-methylpyrrolidone, N-methyl-caprolactam.

For adjusting the viscosity, one or more thickeners and/or binders may be added to the solutions or dispersions of the conductive polymers. Suitable thickeners and binders are, for example, carrageenans, polyurethane-based thickeners (e.g. Borchigel L 75 from Borchers), polysaccharides, polyvinylpyrrolidone, polyethylene oxides, agar agar, tragacanth, gum arabic, alginates, pectins, guar flour, locust bean flour, starches, dextrins, gelatins, casein, carboxymethyl-cellulose and other cellulose ethers, hydroxyethylcellulose, hydroxypropyl-cellulose, polyurethanes, polyvinyl acetates, polyvinylbutyral, polyacrylic acid esters, polymethacrylic acid esters, polystyrene, polycarbonates, polyacrylonitrile, polyvinyl chloride, polybutadiene, polyisoprene, polyethers, polyesters, silicones, styrene/acrylic acid ester, vinyl acetate/acrylic acid ester and ethylene/vinyl acetate copolymers, polyvinyl alcohols, polyamides, polyurethanes, polyacrylates or polyolefins. The thickeners and binders based on organic monomers may be used in the form of homopolymers or in the form of copolymers. They are used in the form of water-soluble polymers or polymers which are dispersible or emulsifiable in water. In order to improve their compatibility with water, it has proved expedient to use partially sulfonated polymers.

Preferred organic binders are polyurethanes, optionally in combination with other binders.

The screen-printing pastes may further comprise crosslinkers, such as, for example, epoxysilanes, such as 3-glycidoxypropyltrialkoxysilane, and/or additives, such as, for example, surface-active compounds. It is further possible to add alkoxysilane hydrolysates, for example based on tetraethoxysilane, in order to increase the scratch resistance of the resulting coatings.

Suitable additives for increasing the conductivity of the resulting conductive electrode layer may also be added to the screen-printing pastes, which additives are described in EP-A 686 662, for example. Particularly suitable for this purpose are compounds containing ether groups, such as, for example, tetrahydrofuran, compounds containing lactone groups, such as γ-butyrolactone, γ-valerolactone, compounds containing amide or lactam groups, such as caprolactam, N-methylcaprolactam, N,N-dimethylacetamide, N-methylacetamide, N,N-dimethylformamide (DMF), N-methylformamide, N-methylformanilide, N-methylpyrrolidone (NMP), N-octylpyrrolidone, pyrrolidone, sulfones and sulfoxides, such as, for example, sulfolan (tetramethylenesulfone), dimethyl sulfoxide (DMSO), sugars or sugar derivatives, such as, for example, saccharose, glucose, fructose, lactose, sugar alcohols, such as, for example, sorbitol, mannitol, furan derivatives, such as, for example, 2-furancarboxylic acid, 3-furancarboxylic acid, and/or di- or poly-alcohols, such as, for example, ethylene glycol, glycerol, di- and tri-ethylene glycol. Particular preference is given to the use of tetrahydrofuran, N-methylformamide, N-methylpyrrolidone, dimethylsulfoxide or sorbitol as conductivity-increasing additives.

Fillers for achieving the desired rheology may further be added to the screen-printing pastes. Suitable fillers are metal oxides, such as titanium dioxide, zinc oxide, aluminium oxide; electrically conductive metal oxides, such as indium-tin oxide, antimony-tin oxide; metals, such as silver, copper, gold, palladium, platinum; silicon dioxide, silicates, silicas, polysilicic acids, zeolites, alkaline earth carbonates, such as calcium carbonate, sheet silicates and clay minerals, such as montmorillonites or bentonites.

The binders, thickeners, crosslinkers, fillers and/or optionally the additives listed above remain wholly or partially in the conductive electrode layer after application and optional subsequent drying. According to the invention, therefore, they may also be constituents of the conductive electrode layer in the electroluminescent arrangement according to the invention.

There may also be added to the screen-printing pastes crosslinkers already mentioned above and also surface-active compounds, such as flow agents, surfactants and/or antifoams.

Commercially available screen-printing pastes are also available for the application of the conductive electrode layer comprising at least one conductive polymer. An example of a suitable screen-printing paste which may be mentioned here is the commercially available screen-printing paste known by the name Baytron® S V2 (H. C. Starck GmbH) containing poly(3,4-ethylenedioxythiophene) cations and polystyrene sulfonate.

The screen-printing pastes can be processed on commercial screen-printing machines with polyester or metal screen coverings. Processing by means of rotary screen printing or tampon printing is also possible.

After printing, the coatings are dried. Suitable drying temperatures are from 0° C. to 250° C. Drying at elevated temperature, that is to say at from 50 to 150° C., is preferred. The drying time is from a few seconds to several hours, preferably from 10 seconds to 15 minutes.

An electroluminescent arrangement according to the invention can accordingly be produced, for example, by applying a transparent electrode to a transparent carrier film by vapour deposition or by means of screen printing. After drying and optionally after the application of bus-bars through an appropriate mask and repeated drying, the electroluminescent layer is applied thereto and is dried. Then the dielectric layer is applied thereto and is dried. The conductive electrode layer is applied to the dielectric layer either as an intermediate layer or as the counter-electrode and is dried, the counter-electrode subsequently being applied to the intermediate layer and likewise dried or alternatively, a counter-electrode that does not comprise a conductive polymer first being applied and dried, a conductive electrode layer then being applied thereto and dried.

The conductive electrode layers 2, 5 and 6 may also be applied in textured form and differ from the layout of the other layers thereby. For example, the simple representation of symbols such as letters and numbers is possible as a result.

The electroluminescent arrangements according to the invention are outstandingly suitable for the production of shaped electroluminescent arrangements because, surprisingly, no non-lighting faulty areas occur after shaping during subsequent operation. Such three-dimensionally shaped electroluminescent arrangements according to the invention are suitable, for example, for the production of luminous keypads, for example for mobile telephones, luminous symbols, for example in motor vehicles (dashboards, etc.) and also luminous displays in domestic appliances, such as, for example, coffee machines, vacuum cleaners, etc..

### EXAMPLES

### Comparison Example

The following layers are applied in succession by means of the screen-printing process, using commercially available screen-printing pastes (screen-printing inks), to a 200 μm thick polycarbonate film 1 in DIN A 4 format (Makrofol® DE 1-1, Bayer AG).
1. Transparent electrode 2 using Baytron® S V2 (screen-printing paste based on poly(3,4-ethylenedioxythiophene)/polystyrene sulfonate/H.C. Starck GmbH)
2. Electroluminescent layer 3 using a printing paste prepared by mixing Durel Pigment 1IPHS001 (ZnS, luminescent green) and solvent/binder mixture 1INR001 in a mixing ratio of 5.4:4.6)
3. Two dielectric layers 4 using Durel paste 1IND001 (screen-printing paste based on barium titanate)
4. Conductive silver counter-electrode 5 using Durel paste 1INC001 (screen-printing paste based on silver flocks).

The individual layers are each dried for 15 minutes at 130° C. in a circulating-air oven and cooled to room temperature (23° C.).

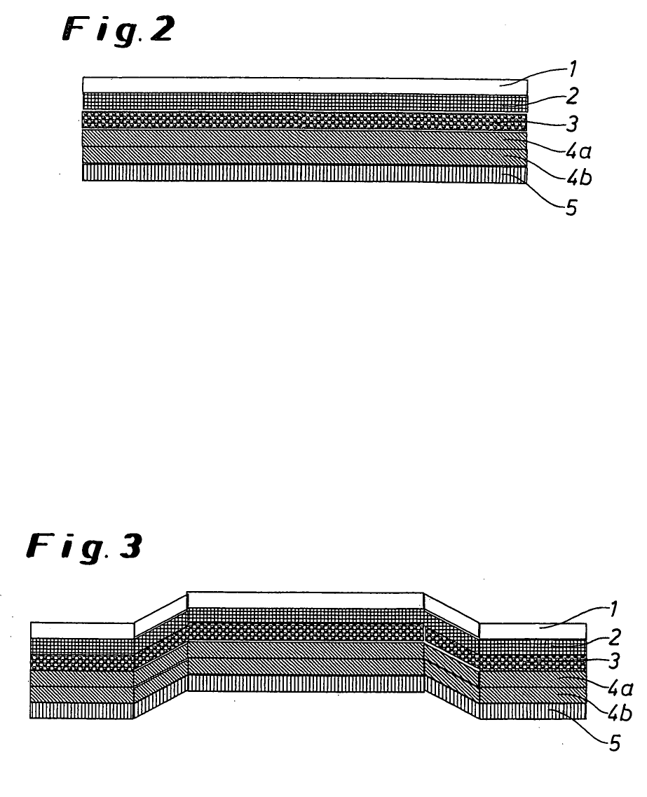

The structure of the electroluminescent arrangement is shown in diagrammatic form in FIG. 1 and FIG. 2. In the Figure: 1=transparent carrier film, 2=transparent electrode, 3=electroluminescent layer, 4a and 4b=dielectric layer, 5=conductive silver counter-electrode.

The electroluminescent arrangement is then shaped by deep-drawing at 250° C. The cross-section of the shaped electroluminescent arrangement is shown in diagrammatic form in FIG. 3.

FIG. 2: Electroluminescent arrangement before shaping (side view)

FIG. 3: Electroluminescent arrangement after shaping (side view)

An alternating voltage of 100 V and 400 Hz is applied to both electrodes. After shaping, the dotted areas light only partially.

### Example 1 (According to the Invention)

To-the counter-electrode 5 of an electroluminescent arrangement produced according to the Comparison Example there is additionally applied a conductive electrode layer 6 using the screen-printing paste Baytron® S V2 (H.C. Starck GmbH) in a wet film thickness of about 15 μm.

The layer is likewise dried for 15 minutes at 130° C. The electroluminescent arrangement according to the invention is then shaped by deep-drawing at 250° C in the same shape as described in the Comparison Example. After shaping, contact is made with the two electrodes and an alternating voltage of 100 V and 400 Hz is applied. The whole of the electrode lights over its entire surface. Non-lighting areas in the form of cracks are not discernible.

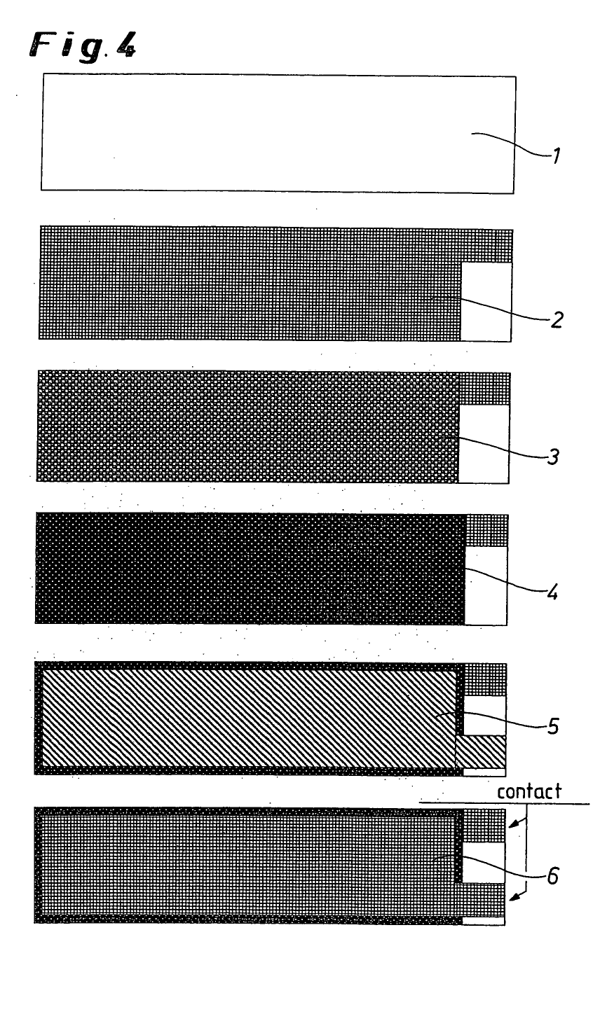

The structure of the electroluminescent arrangement is shown in diagrammatic form in FIG. 4. In the Figure: 1=transparent carrier film, 2=transparent electrode, 3=electroluminescent layer, 4a and 4b=dielectric layer, 5=conductive silver counter-electrode, 6=conductive electrode layer.

### Example 2 (According to the Invention)

An electroluminescent arrangement is produced according to the Comparison Example, with the difference that, instead of the conductive silver counter-electrode 5, the conductive electrode layer 6 is applied directly to the second dielectric layer 4b using the screen-printing paste Baytron® S V2 (H.C. Starck GmbH). A further counter-electrode is dispensed with completely.

The screen-printing paste Baytron® S V2 is applied to the dielectric layer 4b as described in Example 1 in a wet film thickness of about 15 μm and is then dried for 15 minutes at 130° C. The electroluminescent arrangement according to the invention is then shaped by deep-drawing at 250° C. in the same shape as described in the Comparison Example. After shaping, contact is made with the two electrodes and an alternating voltage of 100 V and 400 Hz is applied. The whole of the electrode lights over its entire surface. Non-lighting areas in the form of cracks are not discernible.

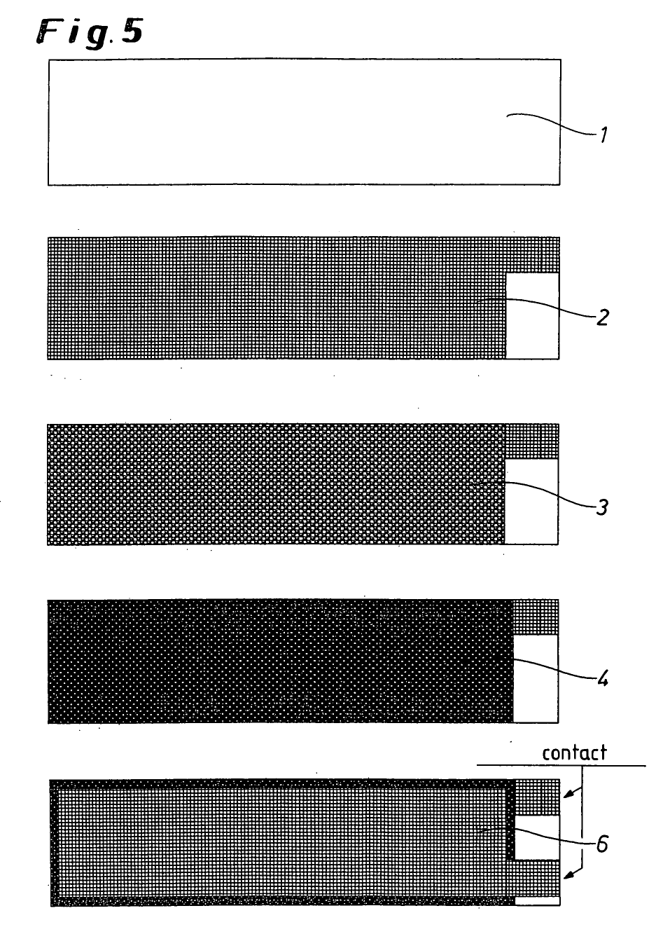

The structure of the electroluminescent arrangement is shown in diagrammatic form in FIG. 5. In the Figure: 1=transparent carrier film, 2=transparent electrode, 3=electroluminescent layer, 4a and 4b=dielectric layer, 6=conductive electrode layer.

### Example 3 (According to the Invention)

To the dielectric layer 4b of an electroluminescent arrangement produced according to the Comparison Example there is applied a conductive electrode layer 6 using the screen-printing paste Baytron® S V2 (H.C. Starck GmbH) in a wet film thickness of about 15 μm.

The layer is likewise dried for 15 minutes at 130° C. The conductive silver electrode 5 is then applied to the layer 6 and dried. The electroluminescent arrangement according to the invention is then shaped by deep-drawing at 250° C. in the same shape as described in the Comparison Example. After shaping, contact is made with the two electrodes and an alternating voltage of 100. V and 400 Hz is applied. The whole of the electrode lights over its entire surface. Non-lighting areas in the form of cracks are not discernible.

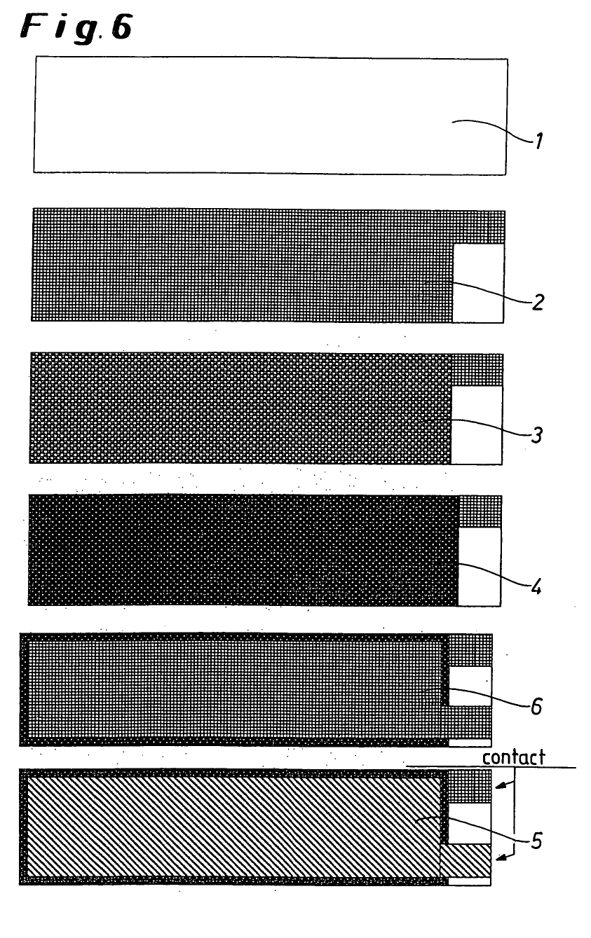

The structure of the electroluminescent arrangement is shown in diagrammatic form in FIG. 6. In the Figure: 1=transparent carrier film, 2=transparent electrode, 3=electroluminescent layer, 4a and 4b=dielectric layer, 6=conductive electrode layer, 5=conductive silver counter-electrode.

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

1. An electroluminescent arrangement comprising:
(a) at least one transparent carrier film;
(b) at least one transparent electrode;
(c) at least one electroluminescent layer;
(d) at least one dielectric layer; and
(e) at least one counter-electrode,
wherein said transparent electrode is interposed between said transparent carrier film and said electroluminescent layer, said dielectric layer is interposed between said electroluminescent layer and said counter-electrode, said transparent carrier film has an exterior surface, and said counter-electrode has an exterior surface,
further wherein one of,
(I) said electroluminescent arrangement further comprises a conductive electrode layer comprising at least one conductive polymer, said conductive electrode layer being one of,
(i) superposed over the exterior surface of said counter-electrode, or
(ii) interposed between said dielectric layer and said counter-electrode,
or
(II) the counter-electrode is a conductive electrode layer comprising at least one conductive polymer.

2. The electroluminescent arrangement of claim 1 wherein the conductive polymer of said conductive electrode layer comprises at least one polymer selected from, the group consisting of polythiophene, polyaniline, polyphenylene, poly(p-phenylenevinylene) and polypyrrole.

3. The electroluminescent arrangement of claim 2 wherein the conductive polymer of said conductive electrode layer is a polythiophene containing repeating units represented by general formula (I), 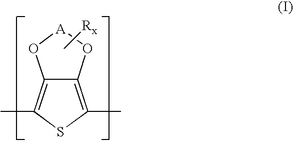
wherein,
A represents a radical selected from the group consisting of C₁-C₅-alkylene radical, and C₁-C₅-alkylene radical substituted with at least one member selected from the group consisting of halogen, ether, thioether, disulfide, sulfoxide, sulfone, sulfonate, amino, aldehyde, keto, carboxylic acid ester, carboxylic acid, carbonate, carboxylate, cyano, alkylsilane, alkoxysilane groups, and carboxylamide,
R represents a radical selected from the group consisting of linear or branched C₁-C₁₈-alkyl radical, C₅-C₁₂-cycloalkyl radical, C₆-C₁₄-aryl radical, C₇-C₁₈-aralkyl radical, C₁-C₄-hydroxyalkyl radical, and hydroxyl radical, and
x represents an integer from 0 to 8,
provided that when x is at least 2, each R may be the same or different.

4. The electroluminescent arrangement of claim 3 wherein the conductive polymer of said conductive electrode layer is a polythiophene containing repeating units of the general formula (Iaa)

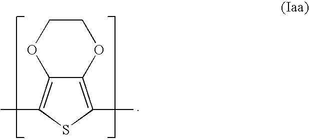

5. The electroluminescent arrangement of claim 1 wherein the conductive electrode layer comprises at least one conductive polymer having a plurality of cation groups, and at least one polyanion.

6. The electroluminescent arrangement of claim 5 wherein the conductive electrode layer comprises 3,4-poly(ethylenedioxythiophene); and polystyrene sulfonate.

7. The electroluminescent arrangement of claim 1 wherein said electroluminescent arrangement is shapable.

8. A process of preparing the electroluminescent arrangement of claim 1 comprising, applying the conductive electrode layer, in a form selected from the group consisting of solution and dispersion, to the counter-electrode.

9. The process of claim 8 wherein the conductive electrode layer is applied by means of screen printing.

10. A shaped article comprising the electroluminescent arrangement of claim 1.

11. The shaped article of claim 10 wherein said shaped article is shaped by means of thermoforming.

12. The shaped article of claim 10 wherein said shaped article is selected from the group consisting of keypads, symbols and displays.
